(19) United States
(12) Patent Application Publication
(10) Pub. No.: US 2020/0122511 A1
(43) Pub. Date: Apr. 23, 2020

(54) PNEUMATIC TIRE

(71) Applicant: TOYO TIRE CORPORATION, Itami-shi (JP)

(72) Inventor: Toshihiko Kanamura, Itami-shi (JP)

(73) Assignee: TOYO TIRE CORPORATION, Itami-shi (JP)

(21) Appl. No.: 16/583,935

(22) Filed: Sep. 26, 2019

(30) Foreign Application Priority Data
Oct. 22, 2018 (JP) 2018-198679

(51) Int. Cl. B60C 11/03; B60C 11/12

(52) U.S. Cl. CPC B60C 11/0302; B60C 11/0304; B60C 2011/0365; B60C 11/1236; B60C 11/1272

(57) ABSTRACT

In a pneumatic tire, a way in which at least one outboard shoulder land groove is inclined with respect to a tire circumferential direction and a way in which at least one outboard middle land groove is inclined with respect to the tire circumferential direction are the same, and a way in which at least one inboard shoulder land groove is inclined with respect to the tire circumferential direction and a way in which at least one inboard middle land groove is inclined with respect to the tire circumferential direction are different.

### CROSS REFERENCE TO RELATED APPLICATIONS

This application claims the benefit of priority of Japanese application no. 2018-198679, filed on Oct. 22, 2018, which is incorporated herein by reference.

### BACKGROUND OF THE INVENTION

### Field of the Invention

The present invention relates to a pneumatic tire.

### Description of the Related Art

Conventionally a pneumatic tire might, for example, comprise a plurality of main grooves extending in the tire circumferential direction, and a plurality of land grooves which are contiguous with the main grooves (e.g., WO2015/005194A). It so happens that there are situations in which a pneumatic tire might be mounted on a vehicle in such fashion as to have negative camber. In addition, there has been demand in recent years for pneumatic tires that are capable of being used in all seasons.

### SUMMARY OF THE INVENTION

The problem is therefore to provide a pneumatic tire which when mounted on a vehicle in such fashion as to have negative camber makes it possible to improve performance with respect to stability in handling in snow and performance with respect to stability in handling during turns.

There is provided a pneumatic tire comprises:

a plurality of main grooves extending in a tire circumferential direction;

a plurality of land grooves that are contiguous with the main grooves;

an indicator region that indicates an orientation in which the tire is to be mounted on a vehicle;

wherein the plurality of main grooves comprise an outboard shoulder main groove arranged in outwardmost fashion when the tire is mounted on the vehicle, and an inboard shoulder main groove arranged in inwardmost fashion when the tire is mounted on the vehicle;

wherein the plurality of land grooves comprise at least one outboard shoulder land groove that is contiguous with an outboard side in a tire width direction of the outboard shoulder main groove, at least one outboard middle land groove that is contiguous with an inboard side in the tire width direction of the outboard shoulder main groove, at least one inboard shoulder land groove that is contiguous with an outboard side in the tire width direction of the inboard shoulder main groove, and at least one inboard middle land groove that is contiguous with an inboard side in the tire width direction of the inboard shoulder main groove;

wherein a way in which the at least one outboard shoulder land groove is inclined with respect to the tire circumferential direction and a way in which the at least one outboard middle land groove is inclined with respect to the tire circumferential direction are the same; and

wherein a way in which the at least one inboard shoulder land groove is inclined with respect to the tire circumferential direction and a way in which the at least one inboard middle land groove is inclined with respect to the tire circumferential direction are different.

Further, the pneumatic tire may have a configuration in which:

wherein the at least one inboard shoulder land groove appears to at least partially overlap the at least one inboard middle land groove as viewed in the tire width direction.

Further, the pneumatic tire may have a configuration in which:

wherein total length of those among the land grooves which are arranged to the inboard side of a tire equatorial plane when the tire is mounted on the vehicle is greater than total area of those among the land grooves which are arranged to the outboard side of the tire equatorial plane when the tire is mounted on the vehicle.

Further, the pneumatic tire may have a configuration in which:

wherein a void fraction attributable to a region between a tire equatorial plane and a contact patch end arranged toward an outboard side when the tire is mounted on the vehicle is less than a void fraction attributable to a region between the tire equatorial plane and a contact patch end arranged toward an inboard side when the tire is mounted on the vehicle.

Further, the pneumatic tire may further include:

a plurality of land portions that are partitioned by the plurality of main grooves and the pair of contact patch ends;

wherein that land portion which of the land portions is arranged next-to-furthest toward the outboard side when the tire is mounted on the vehicle is in a shape of a rib that extends in continuous fashion in the tire circumferential direction.

Further, the pneumatic tire may further include:

a plurality of land portions that are partitioned by the plurality of main grooves and the pair of contact patch ends;

wherein the land portions comprise an inboard middle land portion which of the land portions is arranged next-to-furthest toward the inboard side when the tire is mounted on the vehicle; and

wherein the inboard middle land portion is in a shape of a rib that extends in continuous fashion in the tire circumferential direction, the rib comprising at least an outboard edge of the inboard middle land portion.

Further, the pneumatic tire may further include:

a plurality of middle land portions that are partitioned by those main grooves which of the plurality of main grooves are respectively adjacent thereto;

wherein each of the middle land portions has a width, the widths of the middle land portions increasing with increasing distance from the inboard side when the tire is mounted on the vehicle.

Further, the pneumatic tire may have a configuration in which:

wherein at least one among the at least one inboard shoulder land groove is formed by union of a width groove that is not less than 1.2 mm in width and a sipe that is less than 1.2 mm in width.

Further, the pneumatic tire may have a configuration in which:

wherein at least one among the at least one outboard shoulder land groove is formed by union of a width groove that is not less than 1.2 mm in width and a sipe that is less than 1.2 mm in width.

Further, the pneumatic tire may have a configuration in which:

at least one among the at least one outboard middle land groove is formed by union of a width groove that is not less than 1.2 mm in width and a sipe that is less than 1.2 mm in width.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing a tread surface of the principal components in a pneumatic tire associated with same embodiment as they would exist if unwrapped so as to lie in a single plane;

FIG. 3 is a drawing showing the shape of the contact patch at a pneumatic tire associated with same embodiment when driving straight ahead;

FIG. 4 is a drawing showing the shape of the contact patch at a pneumatic tire associated with same embodiment on an outside wheel during a turn;

FIG. 5 is an enlarged view of region V in FIG. 2; and

FIG. 6 is an enlarged view of region VI in FIG. 2.

### DETAILED DESCRIPTION OF THE INVENTION

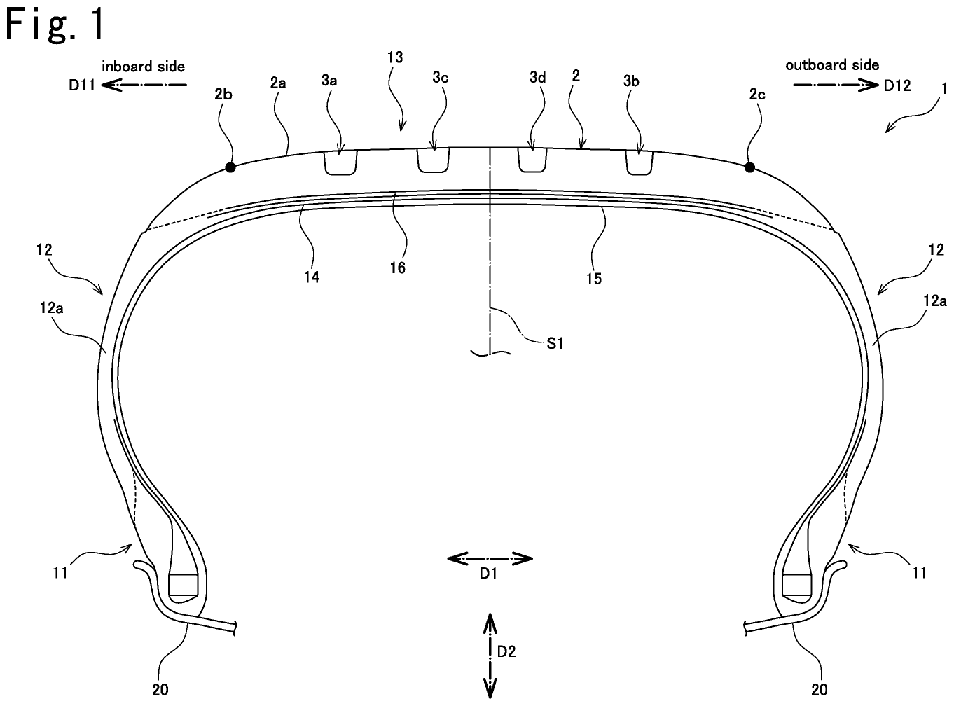

Below, an embodiment of a pneumatic tire is described with reference to FIG. 1 through FIG. 6. At the respective drawings, note that dimensional ratios at the drawings and actual dimensional ratios are not necessarily consistent, and note further that dimensional ratios are not necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire.

In the tire width direction D1, note that the side toward the interior is the side which is nearer to tire equatorial plane S1, and note that the side toward the exterior is the side which is farther from tire equatorial plane S1. Furthermore, in the tire radial direction D2, the side toward the interior is the side which is nearer to the tire rotational axis, and the side toward the exterior is the side away from the tire rotational axis.

Tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the curve formed by the intersection of tire equatorial plane S1 and the outer surface (tread surface 2a, described below) in the tire radial direction D2 of tire 1.

As shown in FIG. 1, tire 1 associated with the present embodiment is provided with a pair of bead regions 11 at which beads are present; sidewall regions 12 which extend outwardly in the tire radial direction D2 from the respective bead regions 11; and tread region 13, the exterior surface in the tire radial direction D2 of which contacts the road surface and which is contiguous with the outer ends in the tire radial direction D2 of the pair of sidewall regions 12. In accordance with the present embodiment, tire 1 is a pneumatic tire 1, the interior of which is capable of being filled with air, and which is capable of being mounted on a rim 20.

Furthermore, tire 1 is provided with carcass layer 14 which spans the pair of beads, and innerliner layer 15 which is arranged at a location toward the interior from carcass layer 14 and which has superior functionality in terms of its ability to impede passage of gas therethrough so as to permit air pressure to be maintained. Carcass layer 14 and innerliner layer 15 are arranged in parallel fashion with respect to the inner circumferential surface of the tire over a portion thereof that encompasses bead regions 11, sidewall regions 12, and tread region 13.

Tire 1 has a structure that is asymmetric with respect to tire equatorial plane S1. In accordance with the present embodiment, tire 1 is a tire for which a vehicle mounting direction is indicated, which is to say that there is an indication of whether the left or the right side of the tire 1 should be made to face the vehicle when tire 1 mounted on rim 20. Moreover, the tread pattern formed at the tread surface 2a at tread region 13 is asymmetric with respect to tire equatorial plane S1.

The orientation in which the tire is to be mounted on the vehicle is indicated at sidewall region 12. More specifically, sidewall region 12 is provided with sidewall rubber 12a which is arranged toward the exterior in the tire width direction D1 from carcass layer 14 so as to constitute the tire exterior surface, said sidewall rubber 12a have an indicator region (not shown) at surface.

For example, one sidewall region 12, i.e., that which is to be arranged toward the interior D11 when the tire is mounted on the vehicle (the left side in the respective drawings; hereinafter also referred to as the “inboard side”), might be marked (e.g., with the word “INSIDE” or the like) so as to contain an indication to the effect that it is for the inboard side. Furthermore, for example, the other sidewall region 12, i.e., that which is to be arranged toward the exterior D12 when the tire is mounted on the vehicle (the right side in the respective drawings; hereinafter also referred to as the “outboard side”), might be marked (e.g., with the word “OUTSIDE” or the like) so as to contain an indication to the effect that it is for the outboard side. Note that the inboard side D11 is the side which is nearer to the vehicle center when tire 1 is mounted on the vehicle, and the outboard side D12 is the side which is farther from the vehicle center when tire 1 is mounted on the vehicle.

Tread region 13 is provided with tread rubber 2 having tread surface 2a which contacts the road surface, and belt layer 16 which is arranged between tread rubber 2 and carcass layer 14. Present at tread surface 2a is the contact patch that actually comes in contact with the road surface, and the portions within said contact patch that are present at the outer ends in the tire width direction D1 are referred to as contact patch ends 2b, 2c.

Note that contact patch end 2b, which of contact patch ends 2b, 2c is that which is arranged toward the inboard side D11, is referred to as inboard contact patch end 2b; and contact patch end 2c, which of contact patch ends 2b, 2c is that which is arranged toward the outboard side D12, is referred to as outboard contact patch end 2c. Further that said contact patch refers to the portion of the tread surface 2a that comes in contact with the road surface when a normal load is applied to a tire 1 mounted on a normal rim 20 when the tire 1 is inflated to normal internal pressure and is placed in vertical orientation on a flat road surface.

Normal rim 20 is that particular rim 20 which is specified for use with a particular tire 1 in the context of the body of standards that contains the standard that applies to the tire 1 in question, this being referred to, for example, as a standard rim in the case of JATMA, a “Design Rim” in the case of IRA, or a “Measuring rim” in the case of ETRTO.

Normal internal pressure is that air pressure which is specified for use with a particular tire 1 in the context of the body of standards that contains the standard that applies to the tire 1 in question, this being maximum air pressure in the case of JATMA, the maximum value listed at the table entitled “TIRE LOAD LIMITS AT VARIOUS COLD INFLATION PRESSURES” in the case of TRA, or “INFLATION PRESSURE” in the case of ETRTO, which when tire 1 is to used on a passenger vehicle is taken to be an internal pressure of 180 KPa.

Normal load is that load which is specified for use with a particular tire 1 in the context of the body of standards that contains the standard that applies to the tire 1 in question, this being maximum load capacity in the case of JATMA, the maximum value listed at the aforementioned table in the case of TRA, or “LOAD CAPACITY” in the case of ETRTO, which when tire 1 is to be used on a passenger vehicle is taken to be 85% of the load corresponding to an internal pressure of 180 KPa.

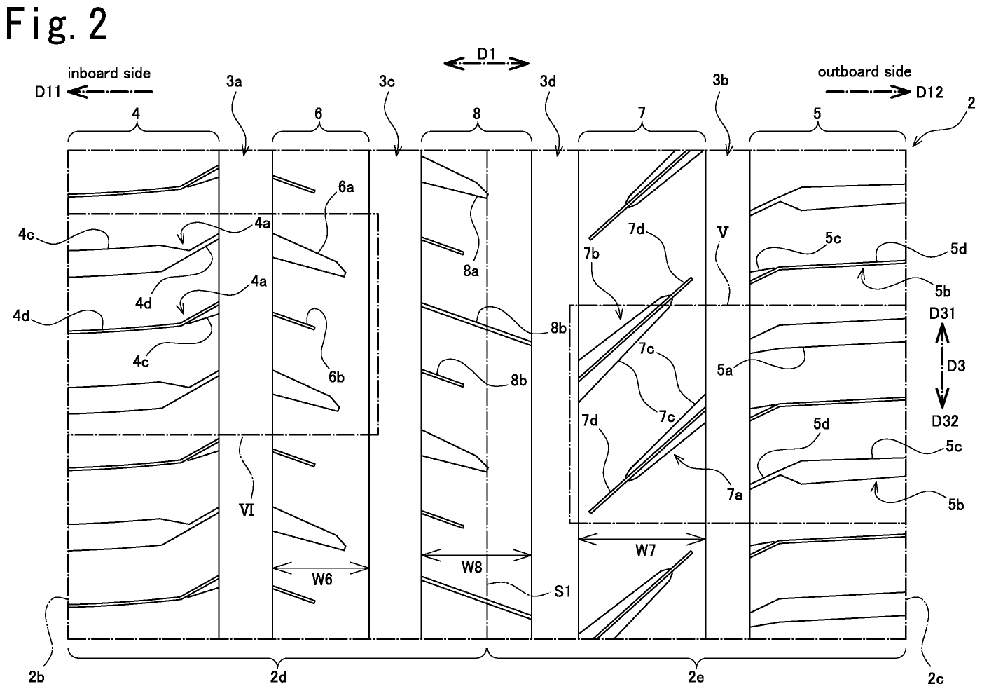

As shown in FIG. 1 and FIG. 2, tread rubber 2 is provided with a plurality of main grooves 3a through 3d extending in the tire circumferential direction D3. Each of the plurality of Main groove 3a through 3d respectively extends continuously in the tire circumferential direction D3. And main grooves 3a through 3d are straight main grooves which extend so as to parallel to the tire circumferential direction D3. Note main grooves 3a through 3d extend in zigzag fashion in the tire circumferential direction D3.

Further main groove 3a through 3d might, for example, be provided with so-called tread wear indicator (s) (not shown) which are portions at which depth of the groove is reduced so as to make it possible to ascertain the extent to which wear has occurred as a result of the exposure thereof that takes place in accompaniment to wear. Furthermore, main groove 3a through 3d might, for example, have a width that is not less than 3% of the distance (dimension in the tire width direction D1) between contact patch ends 2b, 2c. Furthermore, main groove 3a through 3d might, for example, have a width that is not less than 5 mm.

Furthermore, at the plurality of Main groove 3a through 3d, pair of main grooves 3a, 3b arranged at outermost locations in the tire width direction D1 are referred to as shoulder main grooves 3a, 3b, and main grooves 3c, 3d arranged between the pair of shoulder main grooves 3a, 3b are referred to as center main grooves 3c, 3d. In accordance with the present embodiment, the number of center main grooves 3c, 3d that are present is two.

At the shoulder main grooves 3a, 3b, shoulder main groove 3a which is arranged toward the vehicle inboard side D11 is referred to as inboard shoulder main groove 3a, and shoulder main groove 3b which is arranged toward the vehicle outboard side D12 is referred to as outboard shoulder main groove 3b. At the center main grooves 3c, 3d, center main groove 3c which is arranged toward the vehicle inboard side D11 is referred to as inboard center main groove 3c, and center main groove 3d which is arranged toward the vehicle outboard side D12 is referred to as outboard center main groove 3d.

As shown in FIG. 2, tread rubber 2 comprises inboard region 2d, which is that portion of the contact patch which is arranged toward the inboard side D11 thereof; and outboard region 2e, which is that portion of the contact patch which is arranged toward the outboard side D12 thereof. Inboard region 2d is the region between tire equatorial plane S1 and inboard contact patch end 2b, and outboard region 2e is the region between tire equatorial plane S1 and outboard contact patch end 2c.

Furthermore, tread rubber 2 comprises a plurality of land portions 4 through 8 that are partitioned by main grooves 3a through 3d and contact patch ends 2b, 2c. At the plurality of land portions 4 through 8, land portions 4, 5 which are partitioned by shoulder main grooves 3a, 3b and contact patch ends 2b, 2c and which are arranged toward the exterior in the tire width direction D1 from shoulder main grooves 3a, 3b are referred to as shoulder land portions 4, 5, and land portions 6 through 8 which are partitioned by respective main grooves 3a through 3d adjacent thereto and which are arranged between the pair of shoulder land portions 4, 5 are referred to as middle land portions 6 through 8.

Note, of the middle land portions 6 through 8, that land portions 6, 7 which are partitioned by shoulder main groove 3a, 3b and center main groove 3c, 3d are referred to as mediate land portions 6, 7, and that land portion 8 which is partitioned by the center main grooves 3c, 3d is referred to as center land portion 8. In accordance with the present embodiment, center main grooves 3c, 3d are arranged so as to straddle tire equatorial plane S1, this being the case, center land portion 8 are arranged in such fashion as to contain tire equatorial plane S1.

At the shoulder land portions 4, 5, shoulder land portion 4 which is arranged toward the vehicle inboard side D11 is referred to as inboard shoulder land portion 4, and shoulder land portion 5 which is arranged toward the vehicle outboard side D12 is referred to as outboard shoulder land portion 5. At the mediate land portions 6, 7, mediate land portion 6 arranged toward the vehicle inboard side D11 is referred to as inboard mediate land portion (inboard middle land portion) 6, and mediate land portion 7 arranged toward the vehicle outboard side D12 is referred to as outboard mediate land portion (outboard middle land portion) 7.

The land portions 4 through 8 are provided with a plurality of land grooves 4a, 5a, 5b, 6a, 6b, 7a, 7b, 8a, 8b. The plurality of land grooves 4a, 5a, . . . extend so as to intersect the tire circumferential direction D3. Note, land groove(s) of groove width not less than 1.2 mm are referred to as width groove (s), and land groove (s) of groove width less than 1.2 mm are referred to as sipe(s).

In addition, land grooves 4a, 5a, . . . comprise land grooves 5a, 6a, 8a comprising only width grooves; land grooves 6b, 8b comprising only sipes; and land grooves 4a, 5b, 7a, 7b formed by union of width grooves 4c, 5c, 7c and sipes 4d, 5d, 7d. Note, moreover, that land portions 4 through 8 may be provided with land groove(s) that extend in continuous or intermittent fashion in the tire circumferential direction D3 and that are of groove width (s) less than the groove width (s) of main grooves 3a through 3d, such land groove(s) being referred to as circumferential groove (s).

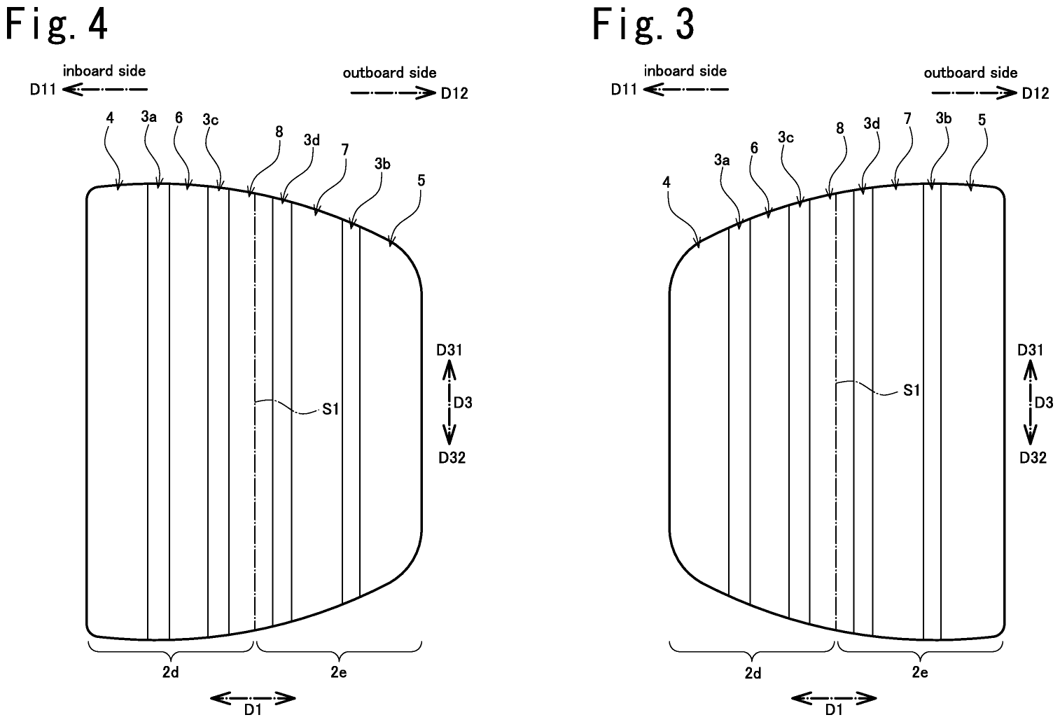

It so happens, as shown in FIG. 3, that the shape of the contact patch of tire 1 on an outside wheel during a turn (land grooves 4a, 5a, . . . are not shown at FIG. 3) will be such that contact patch length (length in the tire circumferential direction D3) will be greater the further one goes toward the outboard side D12. This is because the further one goes toward the outboard side D12 the greater will be the force that acts thereat. Accordingly, performance with respect to stability in handling during turns will be greatly influenced by outboard region 2e.

On the other hand, when tire 1 is mounted on a vehicle in such fashion as to have negative camber, it will be inclined in such a direction as to cause it to be directed from the outboard side D12 to the inboard side D11 as one proceeds from the bottom thereof to the top thereof. As a result, as shown in FIG. 4, the shape of the contact patch of tire 1 when driving straight ahead (land grooves 4a, 5a, . . . are not shown at FIG. 4) will be such that contact patch length will be greater the further one goes toward the inboard side D11. This being the case, performance with respect to stability in handling in snow will be greatly influenced by inboard region 2d.

Description is therefore first given below regarding the constitution with respect to the way in which the inclinations of land grooves 4a, 5a, . . . are directed with respect to the tire circumferential direction D3.

Of the ways in which inclination may be directed with respect to the tire circumferential direction D3, note that the way which is inclined in such fashion as to be increasingly directed toward the outboard side D12 as one proceeds toward one side (hereinafter “the first circumferential direction”; toward the top in FIG. 2 through FIG. 6) D31 in the tire circumferential direction D3 is referred to as being inclined in the first way. Conversely, the way which is inclined in such fashion as to be increasingly directed toward the inboard side D11 as one proceeds in the first circumferential direction D31 is referred to as being inclined in the second way.

That is, at FIG. 2 through FIG. 6, the first way in which inclination may be directed is the way which is directed upward as one proceeds to the right (downward as one proceeds to the left), and the second way in which inclination may be directed is the way which is directed downward as one proceeds to the right (upward as one proceeds to the left). Where it is said that two or more objects are “inclined so as to be directed in the same way,” so long as the objects are inclined in such fashion as to be directed in the same way, this should be understood to include the situation in which the angles of inclination thereof with respect to the tire circumferential direction D3 are different.

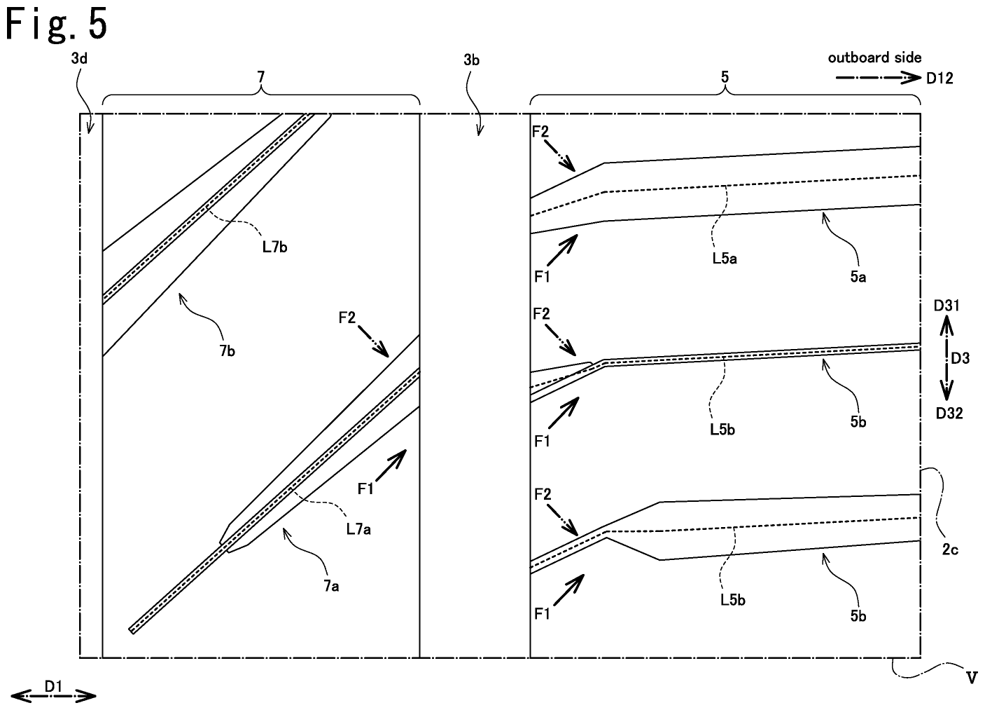

As shown in FIG. 5, those land grooves 5a, 5b which among land grooves 5a, 5b at outboard shoulder land portion 5 are contiguous with the outboard side in the tire width direction D1 of outboard shoulder main groove 3b are referred to as outboard shoulder land grooves 5a, 5b. In accordance with the present embodiment, all of the land grooves 5a, 5b at outboard shoulder land portion 5 are outboard shoulder land grooves 5a, 5b.

Furthermore, those land grooves 7a which among land grooves 7a, 7b at outboard mediate land portion (outboard middle land portion) 7 are contiguous with the inboard side in the tire width direction D1 of outboard shoulder main groove 3b are referred to as outboard middle land grooves 7a. In accordance with the present embodiment, half of the land grooves 7a, 7b at outboard mediate land portion 7 are outboard middle land grooves 7a.

In addition, the entirety of each of outboard shoulder land grooves 5a, 5b is formed so as to be inclined in the first way (the way which is directed upward as one proceeds to the right in FIG. 5) with respect to the tire circumferential direction D3. More specifically, centerlines L5a, L5b of outboard shoulder land grooves 5a, 5b are inclined in the first way with respect to the tire circumferential direction D3 at all locations therealong.

Furthermore, the entirety of each of outboard middle land grooves 7a is formed so as to be inclined in the first way (the way that is directed upward as one proceeds to the right in FIG. 5) with respect to the tire circumferential direction D3. More specifically, centerlines L7a of outboard middle land grooves 7a are inclined in the first way with respect to the tire circumferential direction D3 at all locations therealong.

Thus, the way in which outboard shoulder land grooves 5a, 5b are inclined with respect to the tire circumferential direction D3, and the way in which outboard middle land grooves 7a are inclined with respect to the tire circumferential direction D3, are the same. As a result, at an outside wheel during a turn, outboard shoulder land portion 5 and outboard mediate land portion 7 will deform in the same manner.

For example, at an outside wheel during a turn, when force F1 acts so as to be inclined in the first way (in the direction of the arrows drawn in solid line at FIG. 5) on land portions 5, 7 toward outboard side D12, land portions 5, 7 will deform in a direction parallel to land grooves 5a, 5b, 7a. Furthermore, for example, at an outside wheel during a turn, when force F2 acts so as to be inclined in the second way (in the direction of the arrows drawn in double-dash chain line at FIG. 5) on land portions 5, 7 toward outboard side D12, land portions 5, 7 will deform in such fashion as to squash land grooves 5a, 5b, 7a.

Accordingly, because contact patch pressure will be uniform at outboard shoulder land portion 5 and outboard mediate land portion 7, the coefficient of friction at outboard shoulder land portion 5 and outboard mediate land portion 7 will increase. As a result, because it will be possible to suppress the tendency for sideslip to occur at outboard shoulder land portion 5 and outboard mediate land portion 7, it will be possible to improve performance with respect to stability in handling during turns.

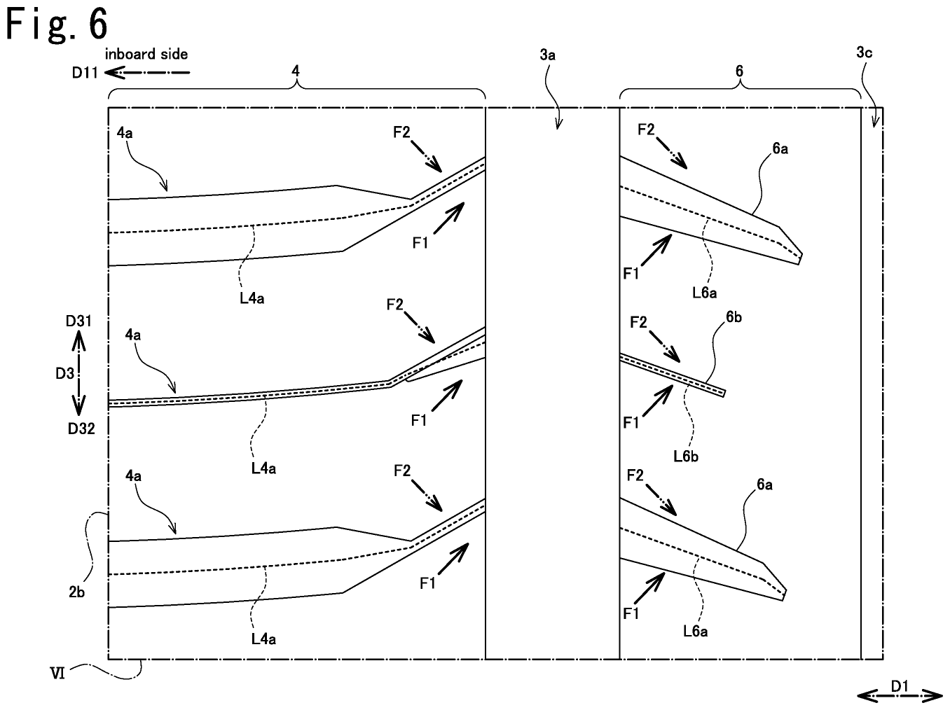

Furthermore, as shown in FIG. 6, those land grooves 4a which among land grooves 4a at inboard shoulder land portion 4 are contiguous with the outboard side in the tire width direction D1 of inboard shoulder main groove 3a are referred to as inboard shoulder land grooves 4a. In accordance with the present embodiment, all of the land grooves 4a at inboard shoulder land portion 4 are inboard shoulder land grooves 4a.

Furthermore, those land grooves 6a, 6b which among land grooves 6a, 6b at inboard mediate land portion (inboard middle land portion) 6 are contiguous with the inboard side in the tire width direction D1 of inboard shoulder main groove 3a are referred to as inboard middle land grooves 6a, 6b. In accordance with the present embodiment, all of the land grooves 6a, 6b at inboard mediate land portion 6 are inboard middle land grooves 6a, 6b.

In addition, the entirety of each of inboard shoulder land grooves 4a is formed so as to be inclined in the first way (the way that is directed upward as one proceeds to the right in FIG. 6) with respect to the tire circumferential direction D3. More specifically, centerlines L4a of inboard shoulder land grooves 4a are inclined in the first way with respect to the tire circumferential direction D3 at all locations therealong.

Furthermore, the entirety of each of inboard middle land grooves 6a, 6b is formed so as to be inclined in the second way (the way that is directed downward as one proceeds to the right in FIG. 6) with respect to the tire circumferential direction D3. More specifically, centerlines L6a, L6b of inboard middle land grooves 6a, 6b are inclined in the second way with respect to the tire circumferential direction D3 at all locations therealong.

Thus, the way in which inboard shoulder land grooves 4a are inclined with respect to the tire circumferential direction D3, and the way in which inboard middle land grooves 6a, 6b are inclined with respect to the tire circumferential direction D3, are different. As a result, when tire 1 travels on a snowy road, because tire 1 is acted on not only by forces from the tire circumferential direction D3 but also by forces from the tire width direction D1, forces F1, F2 in many different directions will act thereon, but regardless of which among said forces F1, F2 one considers, at least one of either inboard shoulder land grooves 4a or inboard middle land grooves 6a, 6b will serve as an effective edge component with respect thereto.

For example, when force F1 acts so as to be inclined in the first way (in the direction of the arrows drawn in solid line at FIG. 6) on land portions 4, 6 toward inboard side D11 from a snowy road, inboard middle land grooves 6a, 6b will serve as an effective edge component, being nearly perpendicular with respect to said force F1. Furthermore, for example, when force F2 acts so as to be inclined in the second way (in the direction of the arrows drawn in double-dash chain line at FIG. 6) on land portions 4, 6 toward inboard side D11 from a snowy road, inboard shoulder land grooves 4a will serve as an effective edge component, being nearly perpendicular with respect to said force F2.

Moreover, inboard shoulder land grooves 4a appear to at least partially overlap inboard middle land grooves 6a, 6b as viewed in the tire width direction D1. Accordingly, as a result of cooperation between inboard shoulder land grooves 4a and inboard middle land grooves 6a, 6b which appear to overlap as viewed in the tire width direction D1, it is possible to improve performance with respect to stability in handling in snow (e.g., during acceleration, braking, turning, or changing lanes).

Description will now be given in terms of the constitution with respect to the lengths of land grooves 4a, 5a, . . . and the void fraction attributable to grooves 3a through 3d, 4a, 5a, . . . . Note that void fraction refers to the ratio of groove area (the sum of the area of main grooves 3a through 3d and the area of land grooves 4a, 5a, . . . ) to contact patch area (the sum of the area of main grooves 3a through 3d and the area of land portions 4 through 8 (including land grooves 4a, 5a, . . . ))_.

First, returning to FIG. 2, the void fraction attributable to outboard region 2e is less than the void fraction attributable to inboard region 2d. As a result, because the volume of the rubber at outboard region 2e will be large, while a large force will act at outboard region 2e at an outside wheel during a turn, rigidity at outboard region 2e will be high. As a result, it will be possible to improve performance with respect to stability in handling during turns.

Furthermore, the total length of land grooves 4a, 6a, 6b, 8a, 8b arranged at inboard region 2d is greater than the total length of land grooves 5a, 5b, 7a, 7b, 8b arranged at outboard region 2e. Note that length of land grooves 4a, 5a, . . . means the length of centerlines L4a, L5a, . . . of land grooves 4a, 5a, . . . .

As a result, when the tire is mounted on a vehicle in such fashion as to have negative camber, to address the fact that the contact patch length toward inboard side D11 will be greater than the contact patch length toward outboard side D12, total length of land grooves 4a, 6a, 6b, 8a, 8b arranged at inboard region 2d is increased. As a result, because the shape of the contact patch will be such that there will be increase in edge components at inboard region 2d, it will be possible to further improve performance with respect to stability in handling in snow.

Next, the constitution associated with middle land portions 6 through 8 will be described below.

Among middle land portions 6 through 8, at an outside wheel during a turn, the greatest force will act on outboard mediate land portion 7. To address this, outboard mediate land portion 7 is in the shape of a rib extending in continuous fashion in the tire circumferential direction D3. As a result, because there will be increase in rigidity at outboard mediate land portion 7, it will be possible to further improve performance with respect to stability in handling during turns.

Note that term rib-shaped as used herein refers to the shape of land portions 4 and 6 through 8 which are not divided in the tire circumferential direction D3 by width groove 4c, 6a, 7c, 8a. Conversely, land portion 5 which is divided in the tire circumferential direction D3 by width groove 5a is referred to as being block-shaped. Accordingly, at each of rib-shaped land portions 4 and 6 through 8, at least one end of width groove 4c, 6a, 7c, 8a is located not at a main groove 3a through 3d but is located at the interior of the land portion 4 and 6 through 8.

It so happens that in accordance with the present embodiment the greater the extent to which middle land portions 7, 8, 6 are located toward outboard side D12 the greater will be groove widths W7, W8, W6. More specifically, width W7 of outboard mediate land portion 7 is greater than width W8 of center land portion 8, and width W8 of center land portion 8 is greater than width W6 of inboard mediate land portion 6.

As a result, at an outside wheel during a turn, to address the fact that the greater the extent to which a middle land portion 7, 8, 6 is located toward outboard side D12 the greater will be the force that acts thereat, the greater the extent to which a middle land portion 7, 8, 6 is located toward outboard side D12 the greater is the rigidity thereat. As a result, it will be possible to further improve performance with respect to stability in handling during turns. Note, however, that there is no particular limitation with respect to the relative magnitudes of widths W6 through W8 of middle land portions 6 through 8.

Further, at center land portion 8 on an outside wheel during a turn, to address the fact that the force that acts thereat will be greater toward outboard side D12 than it will be toward inboard side D11, the portion thereof toward outboard side D12 is not divided by width groove 8a but is continuous in the tire circumferential direction D3. As a result, because there will be increase in rigidity at the portion thereof toward outboard side D12, it will be possible to further improve performance with respect to stability in handling during turns.

Further, at inboard mediate land portion 6 on an outside wheel during a turn, to address the fact that the force that acts thereat will be greater toward outboard side D12 than it will be toward inboard side D11, the portion thereof toward outboard side D12 is not divided by width groove 6a but is continuous in the tire circumferential direction D3. As a result, because there will be increase in rigidity at the portion thereof toward outboard side D12, it will be possible to further improve performance with respect to stability in handling during turns.

As described above, the pneumatic tire 1 of the embodiment includes: a plurality of main grooves 3a through 3d extending in a tire circumferential direction D3; a plurality of land grooves 4a, 5a, . . . that are contiguous with the main grooves 3a through 3d; an indicator region that indicates an orientation in which the tire is to be mounted on a vehicle; wherein the plurality of main grooves 3a through 3d comprise an outboard shoulder main groove 3b arranged in outwardmost fashion D12 when the tire is mounted on the vehicle, and an inboard shoulder main groove 3a arranged in inwardmost fashion D11 when the tire is mounted on the vehicle; wherein the plurality of land grooves 4a, 5a, . . . comprise at least one outboard shoulder land groove 5a, 5b that is contiguous with an outboard side in a tire width direction D1 of the outboard shoulder main groove 3b, at least one outboard middle land groove 7a that is contiguous with an inboard side in the tire width direction D1 of the outboard shoulder main groove 3b, at least one inboard shoulder land groove 4a that is contiguous with an outboard side in the tire width direction D1 of the inboard shoulder main groove 3a, and at least one inboard middle land groove 6a, 6b that is contiguous with an inboard side in the tire width direction D1 of the inboard shoulder main groove 3a; wherein a way in which the at least one outboard shoulder land groove 5a, 5b is inclined with respect to the tire circumferential direction D3 and a way in which the at least one outboard middle land groove 7a is inclined with respect to the tire circumferential direction D3 are the same; and wherein a way in which the at least one inboard shoulder land groove 4a is inclined with respect to the tire circumferential direction D3 and a way in which the at least one inboard middle land groove 6a, 6b is inclined with respect to the tire circumferential direction D3 are different.

In accordance with such constitution, because the way in which outboard shoulder land grooves 5a, 5b are inclined with respect to the tire circumferential direction D3 and the way in which outboard middle land grooves 7a are inclined with respect to the tire circumferential direction D3 are the same, outboard shoulder land portion 5 and outboard middle land portion 7 will deform in the same manner at an outside wheel during a turn. This makes it possible to cause contact patch pressure to be uniform at outboard shoulder land portion 5 and outboard middle land portion 7.

Accordingly, because the coefficient of friction at outboard shoulder land portion 5 and outboard middle land portion 7 will increase, it will be possible to suppress the tendency for sideslip to occur at outboard shoulder land portion 5 and outboard middle land portion 7. As a result, it will be possible to improve performance with respect to stability in handling during turns.

On the other hand, when the tire is mounted on a vehicle in such fashion as to have negative camber, because the contact patch length toward inboard side D11 will be greater than the contact patch length toward outboard side D12, the fractional percentage represented by those edge components which of the edge components that make up the shape of the contact patch are attributable to inboard shoulder land grooves 4a and inboard middle land grooves 6a, 6b is increased. As a result, inboard shoulder land grooves 4a and inboard middle land grooves 6a, 6b will contribute greatly to performance with respect to stability in handling in snow.

The way in which inboard shoulder land grooves 4a are inclined with respect to the tire circumferential direction D3, and the way in which in board middle land grooves 6a, 6b are inclined with respect to the tire circumferential direction D3, are therefore different. As a result, regardless the direction in which forces F1, F2 act on tire 1 from the snowy road, at least one of either inboard shoulder land grooves 4a or inboard middle land grooves 6a, 6b will serve as an effective edge component with respect thereto. Accordingly, as a result of cooperation between inboard shoulder land grooves 4a and inboard middle land grooves 6a, 6b, it will be possible to improve stability in handling in snow.

Further, in the pneumatic tire 1 of the embodiment, wherein the at least one inboard shoulder land groove 4a appears to at least partially overlap the at least one inboard middle land groove 6a, 6b as viewed in the tire width direction D1.

In accordance with such constitution, at least one of either inboard shoulder land grooves 4a or inboard middle land grooves 6a, 6b, which appear to overlap as viewed in the tire width direction D1, will serve as an effective edge component. Accordingly, as a result of cooperation between inboard shoulder land grooves 4a and inboard middle land grooves 6a, 6b, which appear to overlap as viewed in the tire width direction D1, it will be possible to further improve performance with respect to stability in handling in snow.

Further, in the pneumatic tire 1 of the embodiment, wherein total length of those among the land grooves 4a, 6a, 6b, 8a, 8b which are arranged to the inboard side D11 of a tire equatorial plane S1 when the tire is mounted on the vehicle is greater than total area of those among the land grooves 5a, 5b, 7a, 7b, 8b which are arranged to the outboard side D12 of the tire equatorial plane S1 when the tire is mounted on the vehicle.

In accordance with such constitution, when the tire is mounted on a vehicle in such fashion as to have negative camber, to address the fact that the contact patch length toward inboard side D11 will be greater than the contact patch length toward outboard side D12, total length of land grooves 4a, 6a, 6b, 8a, 8b arranged to the inboard side D11 of tire equatorial plane S1 is increased. As a result, because the shape of the contact patch will be such that there will be increase in edge components at inboard region 2d when the tire is mounted on the vehicle, it will be possible to further improve performance with respect to stability in handling in snow.

Further, in the pneumatic tire 1 of the embodiment, wherein a void fraction attributable to a region 2e between a tire equatorial plane S1 and a contact patch end 2c arranged toward an outboard side D12 when the tire is mounted on the vehicle is less than a void fraction attributable to a region 2d between the tire equatorial plane S1 and a contact patch end 2b arranged toward an inboard side D11 when the tire is mounted on the vehicle.

In accordance with such constitution, because the void fraction attributable to region 2e between tire equatorial plane S1 and contact patch end 2c arranged toward the outboard side D12 when the tire is mounted on the vehicle is low, the volume of the rubber at outboard region 2e is made large. As a result, at an outside wheel during a turn, while a large force will act at outboard region 2e, because rigidity at outboard region 2e will be high, it will be possible to further improve performance with respect to stability in handling during turns.

Further, the pneumatic tire 1 of the embodiment further includes: a plurality of land portions 4 through 8 that are partitioned by the plurality of main grooves 3a through 3d and the pair of contact patch ends 2b, 2c; wherein that land portion which of the land portions 4 through 8 is arranged next-to-furthest toward the outboard side D12 when the tire is mounted on the vehicle is in a shape of a rib that extends in continuous fashion in the tire circumferential direction D12.

In accordance with such constitution, land portion 7 which is arranged next-to-furthest toward the outboard side D12 when the tire is mounted on a vehicle is not block-shaped, i.e., divided in the tire circumferential direction D3; but is rib-shaped, i.e., extends in continuous fashion in the tire circumferential direction D3. As a result, at an outside wheel during a turn, while a large force will act at outboard region 2e, because rigidity at said land portion 7 will be high, it will be possible to further improve performance with respect to stability in handling during turns.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that inboard shoulder land grooves 4a appear to at least partially overlap inboard middle land grooves 6a, 6b as viewed in the tire width direction D1. However, while such constitution is preferred, pneumatic tire 1 is not limited to such constitution. For example, it is also possible to adopt a constitution in which inboard shoulder land grooves 4a are separated from inboard middle land grooves 6a, 6b in the tire circumferential direction D3.

(2) Furthermore, the constitution of pneumatic tire 1 associated with the foregoing embodiment is such that the total length of land grooves 4a, 6a, 6b, 8a, 8b arranged at inboard region 2d is greater than the total length of land grooves 5a, 5b, 7a, 7b, 8b arranged at outboard region 2e. However, while such constitution is preferred, pneumatic tire 1 is not limited to such constitution. For example, it is also possible to adopt a constitution in which the total length of land grooves 4a, 6a, 6b, 8a, 8b arranged at inboard region 2d is not greater than the total length of land grooves 5a, 5b, 7a, 7b, 8b arranged at outboard region 2e.

(3) Furthermore, the constitution of pneumatic tire 1 associated with the foregoing embodiment is such that the void fraction attributable to outboard region 2e is less than the void fraction attributable to inboard region 2d. However, while such constitution is preferred, pneumatic tire 1 is not limited to such constitution. For example, it is also possible to adopt a constitution in which the void fraction attributable to outboard region 2e is not less than the void fraction attributable to inboard region 2d.

(4) Furthermore, the constitution of pneumatic tire 1 associated with the foregoing embodiment is such that land portion 7 which is arranged next-to-furthest toward the outboard side D12 is in the shape of a rib extending in continuous fashion in the tire circumferential direction D3. However, while such constitution is preferred, pneumatic tire 1 is not limited to such constitution. For example, it is also possible to adopt a constitution in which land portion 7 which is arranged next-to-furthest toward the outboard side D12 is in the shape of blocks, being divided in the tire circumferential direction D3.

(5) Furthermore, the constitution of pneumatic tire 1 associated with the foregoing embodiment is such that the number of main grooves 3a through 3d that are present is four. However, pneumatic tire 1 is not limited to such constitution. For example, it is also possible to adopt a constitution in which the number of main grooves 3a through 3d that are present is two or three or is five or more.

(6) Furthermore, the constitution of pneumatic tire 1 associated with the foregoing embodiment is such that all of the land grooves 4a at inboard shoulder land portion 4 are inclined in the same way with respect to the tire circumferential direction D3. However, while such constitution is preferred, pneumatic tire 1 is not limited to such constitution. For example, it is also possible to adopt a constitution in which inboard shoulder land portion 4 comprises not only inboard shoulder land grooves 4a that are contiguous with inboard shoulder main groove 3a but also land grooves that are separated from inboard shoulder main groove 3a, wherein the way in which said land grooves are inclined with respect to the tire circumferential direction D3 is different from the way in which inboard shoulder land grooves 4a are inclined with respect to the tire circumferential direction D3.

(7) Furthermore, the constitution of pneumatic tire 1 associated with the foregoing embodiment is such that all of the land grooves 5a, 5b at outboard shoulder land portion 5 are inclined in the same way with respect to the tire circumferential direction D3. However, while such constitution is preferred, pneumatic tire 1 is not limited to such constitution. For example, it is also possible to adopt a constitution in which outboard shoulder land portion 5 comprises not only outboard shoulder land grooves 5a, 5b that are contiguous with outboard shoulder main groove 3b but also land grooves that are separated from outboard shoulder main groove 3b, wherein the way in which said land grooves are inclined with respect to the tire circumferential direction D3 is different from the way in which outboard shoulder land grooves 5a, 5b are inclined with respect to the tire circumferential direction D3.

(8) Furthermore, the constitution of pneumatic tire 1 associated with the foregoing embodiment is such that all of the land grooves 6a, 6b at inboard middle land portion 6 are inclined in the same way with respect to the tire circumferential direction D3. However, while such constitution is preferred, pneumatic tire 1 is not limited to such constitution. For example, it is also possible to adopt a constitution in which inboard middle land portion 6 comprises not only inboard middle land grooves 6a, 6b that are contiguous with inboard shoulder main groove 3a but also land grooves that are separated from inboard shoulder main groove 3a, wherein the way in which said land grooves are inclined with respect to the tire circumferential direction D3 is different from the way in which inboard middle land grooves 6a, 6b are inclined with respect to the tire circumferential direction D3.

(9) Furthermore, the constitution of pneumatic tire 1 associated with the foregoing embodiment is such that all of the land grooves 7a, 7b at outboard middle land portion 7 are inclined in the same way with respect to the tire circumferential direction D3. However, while such constitution is preferred, pneumatic tire 1 is not limited to such constitution. For example, it is also possible to adopt a constitution in which the way in which outboard middle land grooves 7a that are contiguous with outboard shoulder main groove 3b are inclined with respect to the tire circumferential direction D3 is different from the way in which land grooves 7b that are separated from outboard shoulder main groove 3b are inclined with respect to the tire circumferential direction D3.

1. A pneumatic tire comprising:
a plurality of main grooves extending in a tire circumferential direction;
a plurality of land grooves that are contiguous with the main grooves;
an indicator region that indicates an orientation in which the tire is to be mounted on a vehicle;
wherein the plurality of main grooves comprise an outboard shoulder main groove arranged in outwardmost fashion when the tire is mounted on the vehicle, and an inboard shoulder main groove arranged in inwardmost fashion when the tire is mounted on the vehicle;
wherein the plurality of land grooves comprise at least one outboard shoulder land groove that is contiguous with an outboard side in a tire width direction of the outboard shoulder main groove, at least one outboard middle land groove that is contiguous with an inboard side in the tire width direction of the outboard shoulder main groove, at least one inboard shoulder land groove that is contiguous with an outboard side in the tire width direction of the inboard shoulder main groove, and at least one inboard middle land groove that is contiguous with an inboard side in the tire width direction of the inboard shoulder main groove;
wherein a way in which the at least one outboard shoulder land groove is inclined with respect to the tire circumferential direction and a way in which the at least one outboard middle land groove is inclined with respect to the tire circumferential direction are the same; and
wherein a way in which the at least one inboard shoulder land groove is inclined with respect to the tire circumferential direction and a way in which the at least one inboard middle land groove is inclined with respect to the tire circumferential direction are different.

2. The pneumatic tire according to claim 1
wherein the at least one inboard shoulder land groove appears to at least partially overlap the at least one inboard middle land groove as viewed in the tire width direction.

3. The pneumatic tire according to claim 1
wherein total length of those among the land grooves which are arranged to the inboard side of a tire equatorial plane when the tire is mounted on the vehicle is greater than total area of those among the land grooves which are arranged to the outboard side of the tire equatorial plane when the tire is mounted on the vehicle.

4. The pneumatic tire according to claim 1
wherein a void fraction attributable to a region between a tire equatorial plane and a contact patch end arranged toward an outboard side when the tire is mounted on the vehicle is less than a void fraction attributable to a region between the tire equatorial plane and a contact patch end arranged toward an inboard side when the tire is mounted on the vehicle.

5. The pneumatic tire according to claim 1 further comprising a plurality of land portions that are partitioned by the plurality of main grooves and the pair of contact patch ends;
wherein that land portion which of the land portions is arranged next-to-furthest toward the outboard side when the tire is mounted on the vehicle is in a shape of a rib that extends in continuous fashion in the tire circumferential direction.

6. The pneumatic tire according to claim 1 further comprising a plurality of land portions that are partitioned by the plurality of main grooves and the pair of contact patch ends;
wherein the land portions comprise an inboard middle land portion which of the land portions is arranged next-to-furthest toward the inboard side when the tire is mounted on the vehicle; and
wherein the inboard middle land portion is in a shape of a rib that extends in continuous fashion in the tire circumferential direction, the rib comprising at least an outboard edge of the inboard middle land portion.

7. The pneumatic tire according to claim 1 further comprising a plurality of middle land portions that are partitioned by those main grooves which of the plurality of main grooves are respectively adjacent thereto;
wherein each of the middle land portions has a width, the widths of the middle land portions increasing with increasing distance from the inboard side when the tire is mounted on the vehicle.

8. The pneumatic tire according to claim 1
wherein at least one among the at least one inboard shoulder land groove is formed by union of a width groove that is not less than 1.2 mm in width and a sipe that is less than 1.2 mm in width.

9. The pneumatic tire according to claim 1
wherein at least one among the at least one outboard shoulder land groove is formed by union of a width groove that is not less than 1.2 mm in width and a sipe that is less than 1.2 mm in width.

10. The pneumatic tire according to claim 1 wherein
at least one among the at least one outboard middle land groove is formed by union of a width groove that is not less than 1.2 mm in width and a sipe that is less than 1.2 mm in width.
